(19) United States
(12) Patent Application Publication
(10) Pub. No.: US 2015/0304249 A1
(43) Pub. Date: Oct. 22, 2015

(54) Device and Method for Progressive Media Download with Multiple Layers or Streams

(71) Applicants: Andras VALKÓ, HÄSSELBY (SE); Jörgen GUSTAFSSON, LULEÅ (SE); Fredrik KUIVINEN, JOHANNESHOV (SE)

(72) Inventors: Andras VALKÓ, HÄSSELBY (SE); Jörgen GUSTAFSSON, LULEÅ (SE); Fredrik KUIVINEN, JOHANNESHOV (SE)

(21) Appl. No.: 14/239,284

(22) PCT Filed: Sep. 6, 2011
(86) PCT No.: PCT/IB2011/002060

§ 371 Date: Jul. 14, 2014

(51) Int. Cl. H04L 12/861; H04L 29/06; H04L 12/925

(52) U.S. Cl. CPC H04L 49/9005; H04L 47/722; H04L 65/60

(57) ABSTRACT

A terminal, server, computer readable medium and method for scrolling ahead a desired content while the content is downloading to a terminal. The method includes selecting the desired content for being downloaded in the terminal; starting a first download process for the desired content, wherein the first download process is configured to download a first variant of the desired content; starting a second download process for the desired content, wherein the second download process is configured to download a second variant of the desired content, and the second variant is different from the first variant; offering for playback the first variant; and offering for playback the second variant when a user scrolls ahead the desired content or the first variant becomes unavailable.

### TECHNICAL FIELD

The present invention generally relates to systems, software and methods and, more particularly, to mechanisms and techniques for offering a user scrolling capabilities for smooth and fast access to various portions of a media file.

### BACKGROUND

The evolution of terminals such as tablets, computers, smart phones, game consoles, personal digital assistants, etc., resulted not only in the possibility to consume video or audio content but also to fast forward (scroll) this content.

Progressive download is a way to download desired content from a server to the terminal. Using progressive download, the client application can start playback of the desired content before the entire content is downloaded. When the download starts, the client application stores the beginning of the desired content (e.g., media file) in a playout buffer. This phase is called initial buffering.

When the playout buffer contains a certain amount of the desired content (e.g., the first few seconds), the client application can start playback, while at the same time it continues to download the remaining of the desired content into the playout buffer. If the download speed is high enough, the download is “ahead” of the playback, and hence the user experiences a continuous media experience

If, on the other hand, the download speed is insufficient, or there are temporary connectivity problems between the terminal and the server, then the media playback can “catch up” with the download. This means that the playback can come to a point in the media file that is missing from the playout buffer. At this point, the media playback has to be paused until the download process acquires the necessary content and fills up the playout buffer with a few seconds of media content again. This process is called rebuffering. During this process, the image shown to the viewer is paused or frozen, which is undesirable.

The process of rebuffering is also used when a user scrolls ahead in the media file to a point that is not yet downloaded into the playout buffer. In this case, the playout process is paused and the terminal starts to download the media content from the point where the user scrolled. During this time, no content is shown to the viewer.

Thus, the rebuffering process significantly impacts the user's perceived service quality. For this reason, most users would accept temporary quality degradation rather than having to wait for the rebuffering. As many users actually have this habit of scrolling ahead the media files that they are watching, the network and service providers are looking for a solution to provide content to these users even when scrolling ahead.

Accordingly, it would be desirable to provide devices, systems and methods that are capable of downloading content and providing a continuous supply of the content even when the user scrolls ahead to any point of the content.

### SUMMARY

Assets as, for example, content are desired to be provided to the users and to be continuously (e.g., with no interruptions) available as the user scrolls ahead the content. Thus, a terminal used by the user would ideally be able to download the content when selected by the user and also be able to display the content as the user scrolls it ahead.

To address this problem, there is disclosed a method for scrolling ahead a desired content while the desired content is downloading to a terminal. The method includes a step of selecting the desired content for being downloaded in the terminal and starting at least first and second download processes. The first download process is configured to download a first variant of the desired content and the second download process is configured to download a second variant of the desired content. The second variant is different from the first variant. Thus, the terminal is configured playback the first variant and to playback the second variant when a user scrolls ahead the desired content or the first variant becomes unavailable.

Such a method may be implemented in a terminal that includes an interface configured to receive a user command for downloading the desired content at the terminal and a playout and download controller connected to the interface. The controller is configured to initiate the first and second download processes to obtain first and second variants of the desired content. The controller is also configured to instruct the media player which of the two variants to play. The controller may also be implemented in a server in order to provide the first and second variants to the terminal, depending on whether the user scrolls ahead or not.

The method may also be implemented in a computer readable medium that includes computer executable instructions, wherein the instructions, when executed by a processor, implement the method discussed above.

Thus, it is an object to overcome some of the deficiencies discussed in the previous section and to provide a terminal that downloads various variants of the same content at the same time. One or more of the exemplary embodiments advantageously provides a terminal that continuously provides a user with the desired content as the user scrolls it ahead as a short or no re-buffering process may be needed.

### BRIEF DESCRIPTION OF THE DRAWINGS

The accompanying drawings, which are incorporated in and constitute a part of the specification, illustrate one or more embodiments and, together with the description, explain these embodiments. In the drawings:

FIG. 1 is a schematic diagram of a media file and plural downloading processes according to an exemplary embodiment;

FIG. 2 is a schematic diagram of a process of scrolling ahead in a media file according to an exemplary embodiment;

FIG. 3 is a schematic diagram of a process of scrolling ahead and downloading plural portions of a media file according to an exemplary embodiment;

FIG. 4 is a schematic diagram illustrating a terminal connected to a communication network according to an exemplary embodiment;

FIG. 5 is a schematic diagram of a terminal that handles multiple downloads according to an exemplary embodiment;

FIG. 6 is a schematic diagram of a layered media cache;

FIG. 7 is a flow chart of a method for providing multiple downloads according to an exemplary embodiment; and

FIG. 8 is a schematic diagram of a terminal or server.

### DETAILED DESCRIPTION

The following description of the exemplary embodiments refers to the accompanying drawings. The same reference numbers in different drawings identify the same or similar elements. The following detailed description does not limit the invention. Instead, the scope of the invention is defined by the appended claims. The following embodiments are discussed, for simplicity, with regard to the terminology and structure of a terminal connected to a server from which content is desired to be viewed and thus this content is downloaded onto the terminal via a communication network. However, the embodiments to be discussed next are not limited to these systems but may be applied to other systems.

Reference throughout the specification to “one embodiment” or “an embodiment” means that a particular feature, structure, or characteristic described in connection with an embodiment is included in at least one embodiment of the present invention. Thus, the appearance of the phrases “in one embodiment” or “in an embodiment” in various places throughout the specification is not necessarily all referring to the same embodiment. Further, the particular features, structures or characteristics may be combined in any suitable manner in one or more embodiments.

According to an exemplary embodiment, there is a terminal that is configured to implement a method for scrolling ahead a desired content while the content is downloading at the terminal. The terminal may include a playout and download controller configured to start a first download process for the desired content. The first download process is configured to download a first variant of the desired content. The controller also starts a second download process for the same desired content. The second download process is configured to download a second variant of the desired content, and the second variant is different from the first variant. In this way, the controller may instruct a media player to playback the first variant and also may instruct the media player to playback the second variant instead of the first variant when a user scrolls ahead the desired content or the first variant becomes unavailable.

Thus, two variants of the desired content are available at the same time for viewing, the first variant including the desired content from its beginning while the second variant includes parts of the desired content. These parts may start from a point later in time than the beginning of the desired content or from the beginning of the desired content. The second variant may also be of a lower quality than the first variant so that its download does not significantly affects the downloading of the first variant, which may be the full-scale version of the desired content. In this way, the viewer is offered the first variant for viewing and when the viewer scrolls ahead, the terminal or server is configured to immediately or continuously offer the second variant for viewing and avoid the rebuffering process.

This process is possible as the desired content may be coded using a layered media coding. Layered media coding (or scalable media coding) is a technology where media is coded such that a subset of the coded bit stream can be decoded and used to reconstruct the media, albeit with poorer media quality. For example, the media may be coded to have a basic layer and extra layers. The basic layer, when available, may be used by the playback application of the terminal to provide the user with a viewing of the desired content. If an extra layer is also available, the viewing quality produced by the basic layer and the extra layer is improved. Thus, by having further extra layers, the quality of the displayed desired content continues to increase. In one application, an extra layer can be used by itself by the playback application to display the desired content. In other words, it is possible to have only an extra layer and not the base layer and still offer a viewing of the desired content (at a low quality). In another application, the playback application may use the extra layer “n” only if the basic layer and the previous “n-1” layers are available.

In still another application, instead of using the basic layers and extra layers, the playback application may be configured to use different streams of data for displaying the desired content. For example, a server that stores the desired content may store a first stream which is the full-rate of the desired content but also a second stream that is a low-rate of the desired content. The two streams may be played independently of each other in the terminal. In still another application, the first stream may be coded with a first bit rate while the second stream may be coded with a second bit rate. In yet another application, there is a single stream that is provided by the server storing the desired content but there is an intermediary server that is configured to transcode the single stream, i.e., can change the bit rate of the single stream to provide the first stream and also may allow the stream with the original bit rate to be the second stream.

In the following, the novel concepts discussed in the exemplary embodiments are equally applicable to layered media coding (i.e., content coded to have a base layer and extra layers) but also to the scenario in which different streams are available. For simplicity, in the following, only the layered media coding scheme is discussed.

According to an exemplary embodiment, the traditional single process of sequential download of the desired content (e.g., media file), which starts at the beginning of the media file to be download, is replaced with a plurality of download processes starting at different points in the media file, and using different coding rates. As long as the user is viewing the desired content sequentially, the terminal (or server) plays out the full-rate version of the media file, but at the same time, the terminal receives and stores a low-rate version of another part of the media file, ahead of the playing time.

As a result of this novel concept, if the user scrolls ahead in the media file, there is a high likelihood that the low-rate version is available for immediate viewing and thus, the playout application may start immediately, albeit with inferior media quality, providing the scrolled ahead desired content. The trade off for offering this convenient feature is that the initial buffering may take a longer time (depending on the capacity of the network, the terminal, etc.) than with a traditional single download process.

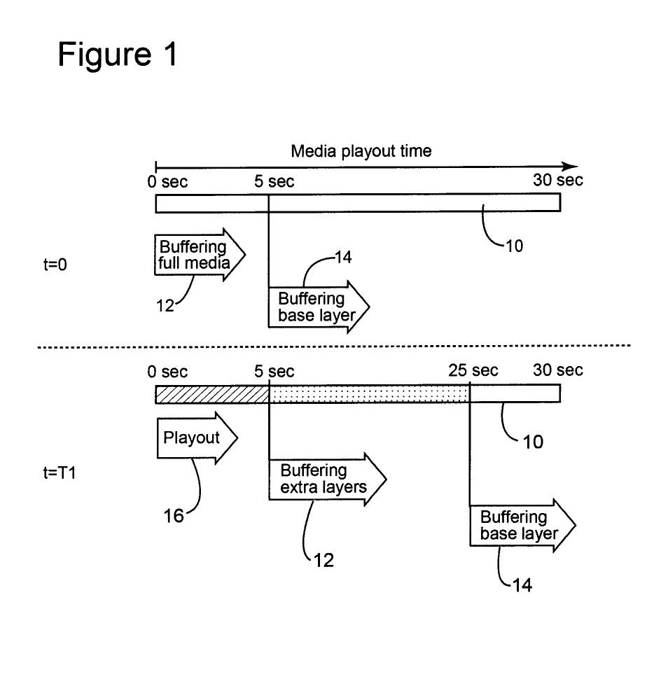

The novel process discussed above is now described with regard to FIG. 1. FIG. 1 illustrates a simple case in which a media file (desired content) 10 has a length of 30 s. Of course, the concepts illustrated herein apply to a file having any length. When the user selects the media file at a time t=0, two download processes are started. The processes may start simultaneously or at different times. For simplicity, FIG. 1 shows the two processes starting at the same time t=0. The first process 12 starts downloading the media file at full rate (i.e., base layer and extra layers or full-scale stream), from the beginning of the media file. The second process 14 starts downloading a low-rate version of the desired content, for example, the base layer for layered media coding. The second process 14 not only downloads a lower quality version of the desired content but also starts the downloading at a point in the media file that corresponds, for example, at a time reference 5 s. In other words, the second download process starts at the same time (actual time t=0) with the first download process but downloads a later in time portion of the media file.

As the two processes advance, at a time t=T1, the first download process 12 has downloaded 5 seconds of the media file at full rate, and the second download process 14 has downloaded the base layer between 5 s and 25 s of the media file 10. At this time, the media playback application in the terminal may start a playout process 16 to display the desired content. The playout process starts from the beginning of the media file 10, while both download processes 12 and 14 continue. It is noted that the first process 12 downloads now the differential layers (i.e., the extra layers and not the base layer as the base layer has already been downloaded by the second process 14). This change in the first process 12 starts at the time reference point 5 s in the media file 10, while the second process 14 continues downloading the base layer from 25 s onwards.

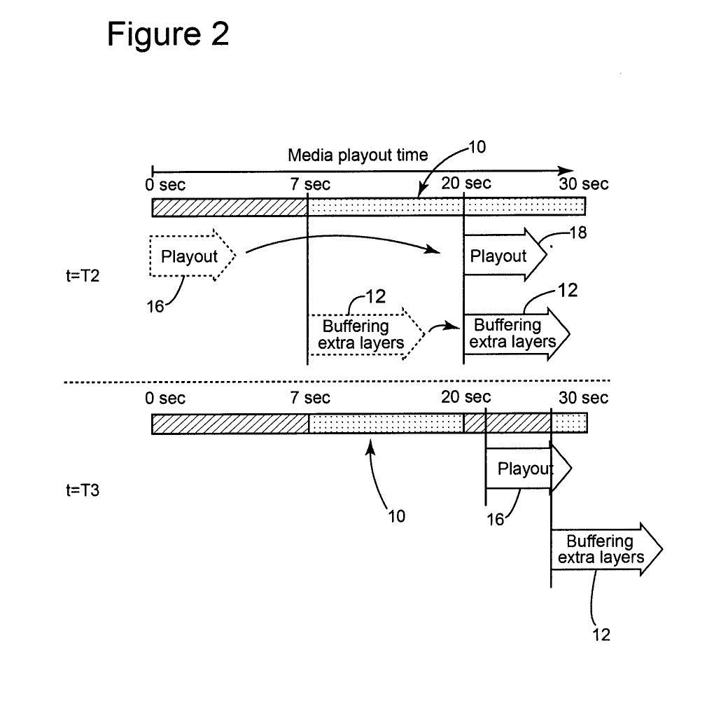

As a result of having two simultaneous download processes 12 and 14, when the user starts viewing the media file 10, a large portion of the media file is available in a buffer of the terminal, coded at base layer. If the user now scrolls ahead in the media file or the first download process 12 is interrupted (e.g., connectivity problems with the server storing the media file), the playback process may start immediately, without waiting to download the content as that content is already available due to the second process 14. This process is illustrated in FIG. 2 as discussed next.

FIG. 2 shows that at a time t=T2, the user scrolls ahead to a point in the media file 10 that corresponds to time mark 20 s of the media file. The new playout process 18 continuously jumps to the time mark 20 s of the media file 10 and resumes displaying the media file 10 without pause as the content of the media file at the time mark 20 s has already been downloaded by the second process 14. However, the quality of the viewing is not as good as that provided by the playout process 16 as the playout process 18 initially uses only the base layer.

At the same time, the first download process 12 also jumps to the time mark 20 s of the media file and starts downloading the differential layers from that point in the media file. Thus, at a time t=T3, the first download process 12 has downloaded the differential layers up to, for example, the time mark 28 s of the media file 10, and the playout process 18 can resume displaying the media file using the full rate coding again. In this particular case, it is noted that the second download process 14 has finished downloading the base layer of the media file 10 and for this reason is not illustrated in FIG. 2. The reader is reminded that times T1, T2, and T3 are current times while the various time marks of the media file 10 are not current times.

Alternatively, if the terminal loses connectivity to the server at time t=T3, the controller of the terminal may be configured to present the user with the part of the media file 10 downloaded by the second download process 14. In other words, although there is no connectivity between the terminal and the server, the playout continuously presents the media file 10 to the user even if some parts of it are missing, e.g., between 7 s and 20 s in FIG. 2. In this way, instead of experiencing total lack of service, the user experiences continuous service but with lower image quality.

The embodiments disclosed with regard to FIGS. 1 and 2 may be changed or modified to optimize the viewing experience. For example, the first and second download processes may start at different times. The terminal or server may start the full-rate download process immediately as the user selects the media file and wants to view it as soon as possible. The terminal or server initiates the second download process if/when the playout has started and there is a sufficient amount of full rate media stored in the cache. Another example for modifying the embodiments of FIGS. 1 and 2 is to have more than two coding layers and/or more than two download processes at the same time.

Another variation may be adjusting the download strategy based on a predicted probability of (i) scrolling ahead or (ii) temporary connectivity problems. The network (e.g., server) or the terminal itself may be configured to determine how often the user scrolls ahead and also what is an average scrolling time for the user, i.e., how much in advance the user scrolls ahead. Thus, this prediction on scrolling can be based on past user behavior or the type of media or other factors. Assuming that a certain user scrolls ahead in average 20 s per movie, the server or the terminal may configure the second download process to download the media file 20 s from the beginning.

The prediction of temporary outage can be based on wireless connectivity conditions, user mobility, etc. Depending on the prediction, the number of download processes, as well as their start and stop times can be optimized. For example, if the server or the terminal determines that a connection between the terminal and the server providing the media file is poor, the second download process may be delayed, or even suppressed. All these predictions may be stored in a server and the terminal may have access to this data.

According to another exemplary embodiment, it is possible that one or more layers are downloaded as distinct parts of the file, not as a continuous file. For example, if the user scrolls to some position of the media file for which the cache does not yet have any downloaded data, the playout starts at a position of the media file where data is available and which is as close as possible to the position the user scrolled to.

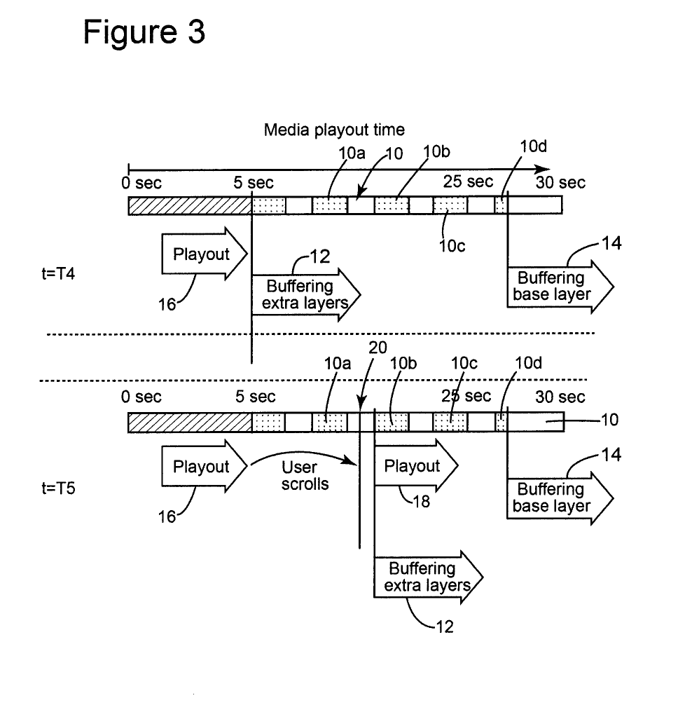

This novel concept is illustrated in FIG. 3 where at time t=T4, the playout process 16 is playing the media file 10, the first download process 12 is buffering extra layers and the second download process 14 is buffering the base layer. It is noted that the second download process 14 has already downloaded portions 10a-c of the media file 10 and it is in the process of downloading a new portion 10d. The portions 10a-c have various sizes and also start at different time marks of the media file 10, i.e., they are not continuous. These starting times may be predetermined by the terminal or the server or may be determined based on the behavior of the user. They also may be adjusted as the terminal and/or server learns more about the behavior of the user.

At time t=T5, the user scrolls ahead to a time mark 20 of the media file that is not in the cache. Thus, the server or the terminal determines that the new playout process 18 should start from a different time mark in the media file that corresponds to available portion 10b. One criterion for determining where to start from when the portion where the user has scrolled to is not available may be the closest available portion, i.e., 10b in this case. In this way, a waiting time is decreased (at the expense of the precision of the scrolling). Note that there is a trade-off between video quality and precision in scrolling. Exactly how to balance between the waiting time and the scrolling precision may depend on user and/or operator preferences and/or may depend on an algorithm which calculates the maximum user perceived quality based on subjective perception of waiting time before the sequence starts playing and the decrease in subjective quality due to scrolling to a position that is not exactly the desired position in the sequence.

Using layered coded media, the total amount of data to be downloaded is not increased compared to state-of-the-art progressive media download. If the media file is not coded this way, as already discussed above, the novel concepts can still be applied by downloading two different streams, a full-rate version and a low-rate version. In this case, however, parts of the media will be downloaded multiple times, which adds to the total amount of data to be downloaded, and to the total download time. However, for a terminal having a high speed connection with the server this might not be a disadvantage. Optionally, the communication network can perform transcoding so that the second stream is obtained by transcoding the first stream.

In this respect, it is possible that the desired content is coded at different bit rates, a first stream being coded at a high bit rate and a second stream being coded at a low bit rate. Also, it is possible that the desired content is transcoded at different bit rates, a first stream being coded or transcoded at a high bit rate and a second stream being coded or transcoded at a low bit rate.

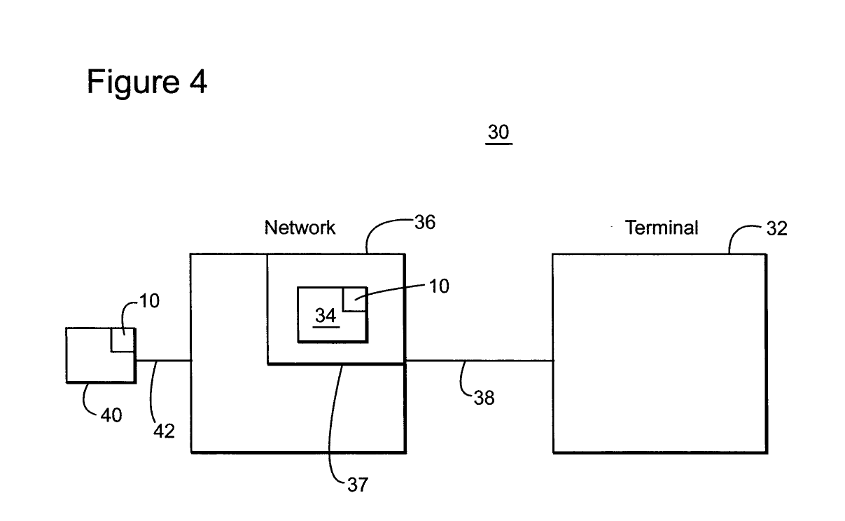

A system 30 that includes a terminal 32 and a server 34 that may be configured to implement the above noted novel concepts are now discussed with regard to FIG. 4. The system 30 includes a communication network 36 that communicates via a link 38 with the terminal 32. The link 38 may be wired or wireless or a combination of both. The communication network 36 may include a server 37 that comprises the cache 34 to store the desired content, i.e., media file 10. However, in another application, a cache 40 may be provided outside the network 36 to store the media file 10. In this situation, the cache 40 may communicate via the network 36 with the terminal 32. A link 42, similar to 38, may be provided between the cache 40 and the network 36.

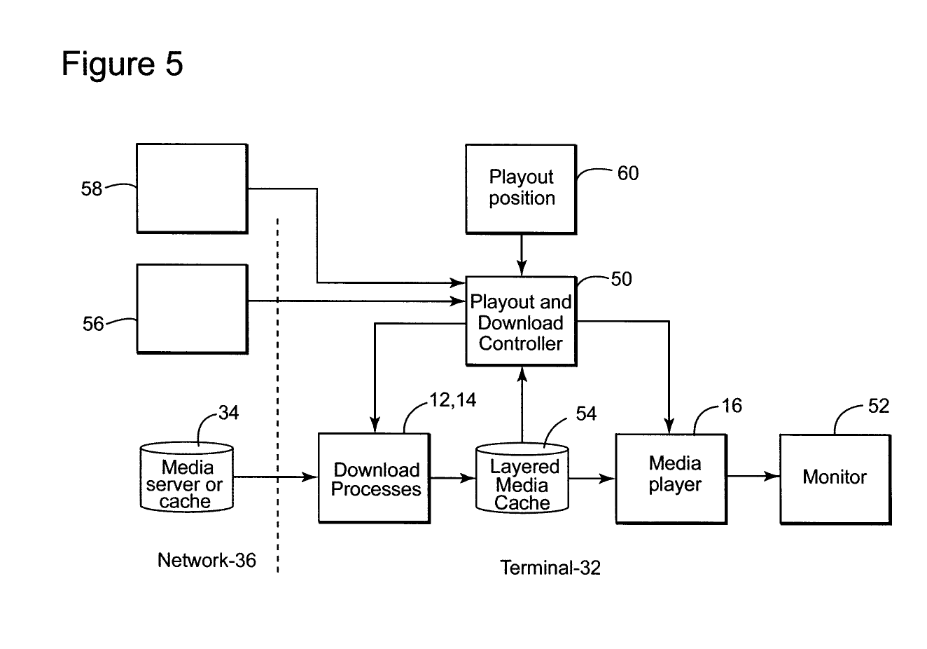

The terminal 32, as illustrated in FIG. 5, may include a playout and download controller 50 that is configured to coordinate and control the download processes 12 and 14. The controller 50 also controls the media player 16 that is configured to display the media file 10 on, for example, a monitor 52. In one embodiment, the controller 50 and media player 16 are implemented in a same element. The monitor 52 may be or not part of the terminal 32. The terminal also includes a layered media cache 54, when coded layered media is used, or another type of cache when other type of coded media is used. The cache 54 may communicate its status (e.g., the amount of the media file download by the first and second download processes) to the controller 50.

The controller 50 may also be in communication with a database 56 of the network or a third party provider that supply behavior information about the user of the terminal 32 or any other information relevant for estimating user scrolling behavior, such as terminal type, geographical information, service characteristics etc. In another embodiment, the network 36 or the third party provider may have a controller 58 that controls the download processes in the terminal so that no or minimal decisions are made in the terminal about the download processes and other processes.

A playout position 60 is acquired by the controller 50 in order to be able to coordinate the scroll process. In other words, based on the playout position 60 and on the contents of the cache 54, the controller 50 controls the media player 16 and creates/stops the download processes 12 and 14. The same may be achieved by the controller 58 in the network or in the third party provider. In another embodiment, the playout and download controller is split, having a component 50 in the terminal and a component 58 in the network.

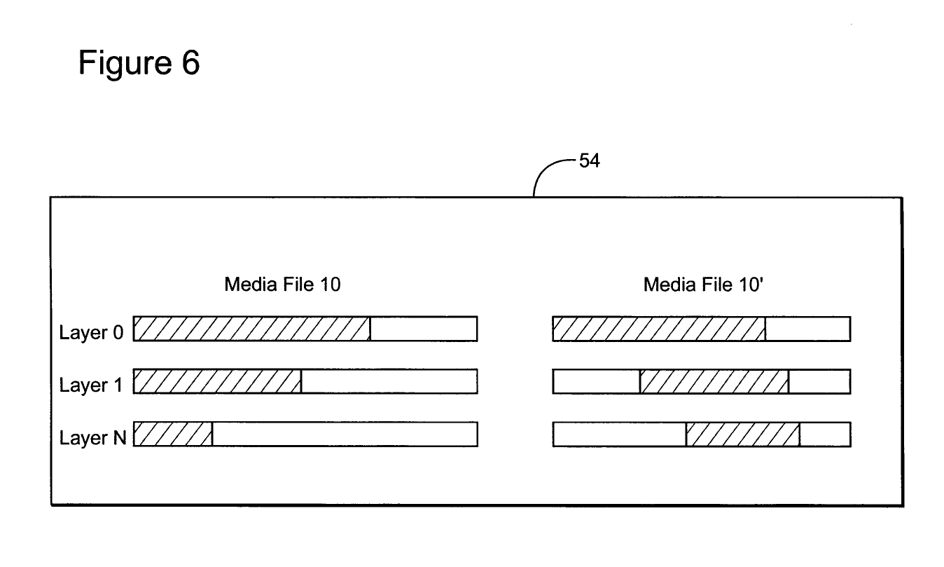

In order to be able to receive the base layer and the extra layer noted above, the terminal 32 uses the layered media cache 54. Cache 54 is illustrated in FIG. 6. FIG. 6 shows the layered media cache 54 including a media file 10 and another media file 10′. Of course, the layered media cache 54 may include a different number of media files. In one application, the layered media cache 54 may include multiple caches. For each media file, the cache can store multiple coding layers, for different portions of the media file. For example, for the media files 10 and 10′, there is a Layer 0 (base layer) that is stored and also extra layers Layers 1 to N. It is noted that for media file 10 the download portion of Layer 0 is larger (time wise) than the download portion of the next layers while for the media file 10′ that is not true. The media file 10 illustrates the situation in which the extra layers need the base layer for displaying the desired content while the media file 10′ illustrates the situation in which any layer may be used by itself to display the desired content.

The Playout and Download Controller 50 may include software commands for achieving the desired download processes. Alternatively, the controller may be hard wired to achieve the desired processes. Also, a combination of both is possible. Assuming that tt denotes a point in the media file that the user wants to play out, TT is the media file length, K and P are pre-set constants (P is the required playout buffer time), then, for any media file that the user has opened, the following algorithm may be implemented:

if (the base layer is not available for the entire media) then

download the base layer's first missing portion after tt, modulo TT;

if (the extension layer is not available between tt and tt+K) then
download the extension layer's first missing portion after tt;

endif

else

if (the extension layer is not available for the entire media) then
download the extension layer's first missing portion after tt, modulo
TT

endif

endif
if (base layer is available between tt and tt+P) then

playout media at tt using the layers available

endif
/a.

Of course, the above example is simplistic and provided only to illustrate one possible approach. Other algorithms, more sophisticated, may be used.

Having the above noted structure in place, a terminal may reduce or eliminate a waiting time at rebuffering, when a user scrolls ahead in a media file. Alternatively, the terminal may reduce or eliminate a waiting time when temporary connectivity problems between the terminal and the server appear. For example, if the second downloading process has downloaded the base layer and the connectivity to the server is lost while the first downloading process still downloads the extra layers, the terminal is still capable of providing the user with the base layer, thus assuring that the user views the content but not necessary with at the best quality available.

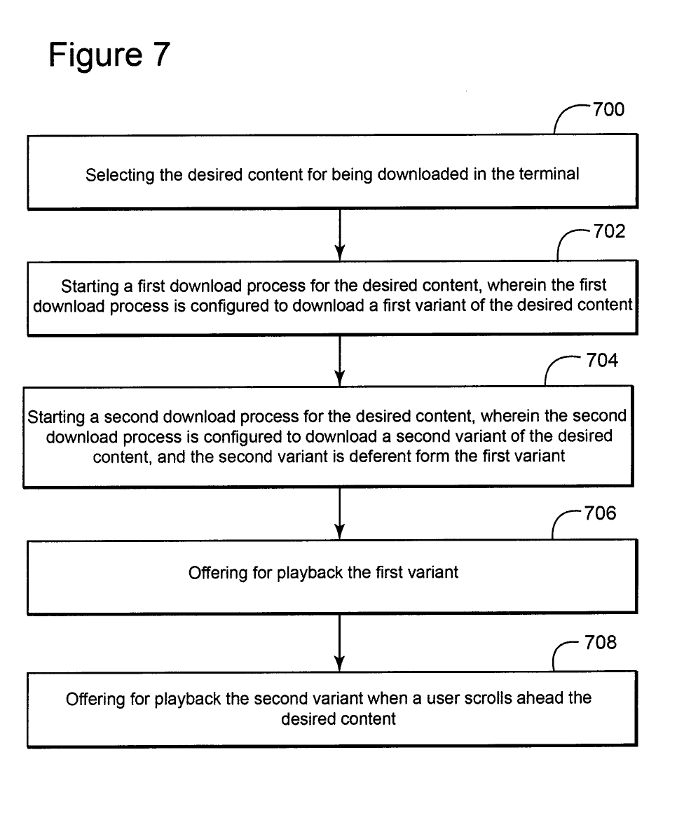

A method for scrolling ahead a desired content while the desired content is downloading to a terminal is now discussed with regard to FIG. 7. The method includes a step 700 of selecting the desired content for being downloaded in the terminal; a step 702 of starting a first download process for the desired content, wherein the first download process is configured to download a first variant of the desired content; a step 704 of starting a second download process for the desired content, wherein the second download process is configured to download a second variant of the desired content, and the second variant is different from the first variant; a step 706 of offering for playback the first variant; and a step 708 of offering for playback the second variant when a user scrolls ahead the desired content.

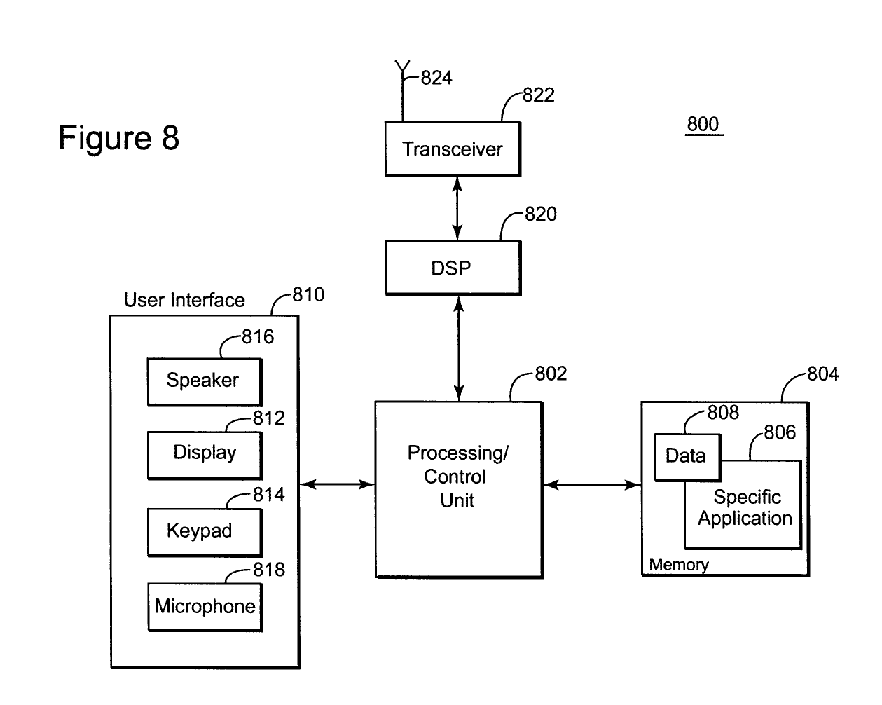

For purposes of illustration and not of limitation, an example of a representative terminal capable of carrying out operations in accordance with the exemplary embodiments is illustrated in FIG. 8.

The exemplary terminal 800 may include a processing/control unit 802, such as a microprocessor, reduced instruction set computer (RISC), or other central processing module. This unit may include the controller 50 discussed with regard to FIG. 5 or may be the controller 50 itself. The processing unit 802 need not be a single device, and may include one or more processors. For example, the processing unit 802 may include a master processor and associated slave processors coupled to communicate with the master processor.

The processing unit 802 may control the basic functions of the system as dictated by programs available in the storage/memory 804. Thus, the processing unit 802 may execute the functions described in FIG. 7. More particularly, the storage/memory 804 may include an operating system and program modules for carrying out functions and applications on the terminal. For example, the program storage may include one or more of read-only memory (ROM), flash ROM, programmable and/or erasable ROM, random access memory (RAM), subscriber interface module (SIM), wireless interface module (WIM), smart card, or other removable memory device, etc. The program modules and associated features may also be transmitted to the terminal 800 via data signals, such as being downloaded electronically via a network, such as the Internet.

One of the programs that may be stored in the storage/memory 804 is a specific program 806. As previously described, the specific program 806 may receive a playout position for controlling a media player. The program 806 and associated features may be implemented in software and/or firmware operable by way of the processor 802. In one exemplary embodiment, the programs 806 and data 808 are stored in non-volatile electrically-erasable, programmable ROM (EEPROM), flash ROM, etc. so that the information is not lost upon power down of the parallel computing system 800.

The processor 802 may also be coupled to user interface 810 elements associated with a mobile terminal. The user interface 810 of the mobile terminal may include, for example, a display 812 such as a liquid crystal display, a keypad 814, speaker 816, and a microphone 818. These and other user interface components are coupled to the processor 802 as is known in the art. The keypad 814 may include alpha-numeric keys for performing a variety of functions, including dialing numbers and executing operations assigned to one or more keys. Alternatively, other user interface mechanisms may be employed, such as voice commands, switches, touch pad/screen, graphical user interface using a pointing device, trackball, joystick, or any other user interface mechanism.

The terminal 800 may also include a digital signal processor (DSP) 820. The DSP 820 may perform a variety of functions, including analog-to-digital (A/D) conversion, digital-to-analog (D/A) conversion, speech coding/decoding, encryption/decryption, error detection and correction, bit stream translation, filtering, etc. The transceiver 822, generally coupled to an antenna 824, may transmit and receive the radio signals associated with a wireless device. However, the transceiver 822 and the antenna 824 may be optional.

The terminal 800 of FIG. 8 is provided as a representative example of a computing environment in which the principles of the present exemplary embodiments may be applied. From the description provided herein, those skilled in the art will appreciate that the present invention is equally applicable in a variety of other currently known and future mobile and fixed computing environments. For example, the specific application 806 and associated features, and data 808, may be stored in a variety of manners, may be operable on a variety of processing devices, and may be operable in mobile devices having additional, fewer, or different supporting circuitry and user interface mechanisms. It is noted that the principles of the present exemplary embodiments are equally applicable to non-mobile terminals, i.e., landline computing systems. Further, a server 37 as illustrated in FIG. 4 may have the structure illustrated in FIG. 8.

The disclosed exemplary embodiments provide a terminal, a method and a server for scrolling ahead a desired content while the content is downloading to the terminal. It should be understood that this description is not intended to limit the invention. On the contrary, the exemplary embodiments are intended to cover alternatives, modifications and equivalents, which are included in the spirit and scope of the invention as defined by the appended claims. Further, in the detailed description of the exemplary embodiments, numerous specific details are set forth in order to provide a comprehensive understanding of the claimed invention. However, one skilled in the art would understand that various embodiments may be practiced without such specific details.

As also will be appreciated by one skilled in the art, the exemplary embodiments may be embodied in a wireless communication device, a telecommunication network, as a method or in a computer program product. Accordingly, the exemplary embodiments may take the form of an entirely hardware embodiment or an embodiment combining hardware and software aspects. Further, the exemplary embodiments may take the form of a computer program product stored on a computer-readable storage medium having computer-readable instructions embodied in the medium. Any suitable computer readable medium may be utilized including hard disks, CD-ROMs, digital versatile disc (DVD), optical storage devices, or magnetic storage devices such a floppy disk or magnetic tape. Other non-limiting examples of computer readable media include flash-type memories or other known memories.

Although the features and elements of the present exemplary embodiments are described in the embodiments in particular combinations, each feature or element can be used alone without the other features and elements of the embodiments or in various combinations with or without other features and elements disclosed herein. The methods or flow charts provided in the present application may be implemented in a computer program, software, or firmware tangibly embodied in a computer-readable storage medium for execution by a specifically programmed computer or processor.

1. A method for scrolling ahead a desired content while the desired content is downloading to a terminal, the method comprising:
selecting the desired content for being downloaded in the terminal;
starting a first download process for the desired content, wherein the first download process is configured to download a first variant of the desired content;
starting a second download process for the desired content, wherein the second download process is configured to download a second variant of the desired content, and the second variant is different from the first variant;
offering for playback the first variant; and
offering for playback the second variant when a user scrolls ahead the desired content or the first variant becomes unavailable.

2. The method of claim 1, further comprising:
downloading simultaneously the first and second variants.

3. The method of claim 2, further comprising:
offering without re-buffering the second variant instead of the first variant when the user scrolls ahead or the first variant is unavailable, wherein the re-buffering is defined as interrupting the playback while downloading content.

4. The method of claim 1, wherein the desired content is coded into a basic layer and extra layers, the first variant includes the basic layer and at least one layer of the extra layers of the desired content and the second variant includes one or more of the extra layers of the same desired content.

5. The method of claim 4, wherein the first variant includes only layers not available from the second variant.

6. The method of claim 1, wherein the desired content is coded at different bit rates, a first stream being coded at a high bit rate and a second stream being coded at a low bit rate, the first variant is the first stream, the second variant is the second stream, and the second variant is playable without a presence of the first variant.

7. The method of claim 1, wherein the desired content is transcoded at different bit rates, a first stream being coded or transcoded at a high bit rate and a second stream being coded or transcoded at a low bit rate, the first variant is the first stream, the second variant is the second stream, and the second variant is playable without a presence of the first variant.

8. The method of claim 1, wherein the first variant starts at a first point of the desired content and the second variant starts at a second point of the desired content that is later in time than the first point.

9. The method of claim 1, further comprising:
interrupting at a first point in the desired content the second download process; and
restarting the second download process at a second point in the desired content, later in time than the first point so that there is a gap between the first point and the second point.

10. The method of claim 9, further comprising:
when the user is provided with the first variant of the desired content and the user scrolls ahead to a point of the desired content that is between the first point and the second point, providing the user with a portion of the second variant that starts at the second point.

11. A terminal configured to implement a method for scrolling ahead a desired content while the content is downloading at the terminal, the terminal comprising:
an interface configured to receive a user command for downloading the desired content at the terminal; and
a playout and download controller connected to the interface and configured to,
start a first download process for the desired content, wherein the first download process is configured to download a first variant of the desired content;
start a second download process for the desired content, wherein the second download process is configured to download a second variant of the desired content, and the second variant is different from the first variant;
instruct a media player to playback the first variant; and
instruct the media player to playback the second variant when a user scrolls ahead the desired content or the first variant becomes unavailable.

12. The terminal of claim 11, wherein the playout and download controller downloads simultaneously the first and second variants.

13. The terminal of claim 11, wherein the playout and download controller is configured to offer without re-buffering the second variant instead of the first variant when the user scrolls ahead or the first variant becomes unavailable, wherein the re-buffering is defined as interrupting the playback while downloading content.

14. The terminal of claim 11, wherein the desired content is coded into a basic layer and extra layers, and
the first variant includes the basic layer and at least one layer of the extra layers of the desired content and the second variant includes one or more of the extra layers of the same desired content; or
the first variant includes only layers not available from the second variant.

15. The terminal of claim 11, wherein the desired content is coded at different bit rates, a first stream being coded at a high density bit rate and a second stream being coded at a low density bit rate, the first variant is the first stream, the second variant is the second stream, and the second variant is playable without a presence of the first variant.

16. The terminal of claim 11, wherein the media player starts the first variant at a first point of the desired content and the second variant at a second point of the desired content that is later in time than the first point.

17. The terminal of claim 11, wherein the first variant is a full-rate version of the desired content and the second variant is a low-rate version of the desired content, the low-rate version having a poor image quality than the full-rate version.

18. The terminal of claim 11, wherein the playout and download controller is further configured to:
interrupt at a first point in the desired content the second download process; and
restart the second download process at a second point in the desired content, later in time than the first point so that there is a gap between the first point and the second point.

19. The terminal of claim 18, wherein the playout and download controller is further configured to:
when the user is provided with the first variant of the desired content and the user scrolls ahead to a point of the desired content that is between the first point and the second point, provide the user with a portion of the second variant that starts at the second point.

20. A computer readable medium including computer executable instructions, wherein the instructions, when executed by a processor, implement a method for scrolling ahead a desired content while the content is downloading to a terminal, the method comprising:
selecting the desired content for being downloaded in the terminal;
starting a first download process for the desired content, wherein the first download process is configured to download a first variant of the desired content;
starting a second download process for the desired content, wherein the second download process is configured to download a second variant of the desired content, and the second variant is different from the first variant;
offering for playback the first variant; and
offering for playback the second variant when a user scrolls ahead the desired content or the first variant becomes unavailable.

21. A server configured to implement a method for scrolling ahead a desired content while the desired content is downloading at a terminal that communicates with the server, the server comprising:
an interface configured to receive from the terminal a user command for viewing the desired content at the terminal; and
a controller connected to the interface and configured, in response to the received user command, to,
provide the terminal with a first variant of the desired content, and
provide the terminal with a second variant of the desired content, wherein the second variant is different from the first variant.

22. The server of claim 21, wherein the desired content is coded into a basic layer and extra layers, and
the first variant includes the basic layer and at least one layer of the extra layers of the desired content and the second variant includes one or more of the extra layers of the same desired content, or
the first variant includes only layers not available from the second variant.

23. The server of claim 21, wherein the desired content is coded at different bit rates, a first stream being coded at a high density bit rate and a second stream being coded at a low density bit rate, the first variant is the first stream, the second variant is the second stream, and the second variant is playable without a presence of the first variant.

24. The server of claim 21, wherein the controller is further configured to:
interrupt at a first point in the desired content the step of providing the second variant; and
provide again the second variant at a second point in the desired content, later in time than the first point so that there is a gap between the first point and the second point.
